(19) United States
(12) Patent Application Publication
(10) Pub. No.: US 2026/0001305 A1
(43) Pub. Date: Jan. 1, 2026

(54) CAVITATED PHA-RICH FILMS AND A METHOD FOR MAKING THE SAME

(71) Applicant: TORAY PLASTICS (AMERICA), INC., North Kingstown, RI (US)

(72) Inventors: Shichen DOU, North Kingstown, RI (US); Joshua R. CLOUTIER, North Kingstown, RI (US)

(21) Appl. No.: 18/757,628

(22) Filed: Jun. 28, 2024

(51) Int. Cl. B32B 27/08; B32B 27/20; B32B 27/36

(52) U.S. Cl. CPC B32B 27/08; B32B 27/205; B32B 27/36; B32B 2250/244; B32B 2264/1022; B32B 2264/104; B32B 2264/302; B32B 2264/303; B32B 2270/00; B32B 2307/308; B32B 2307/31; B32B 2307/414; B32B 2307/518; B32B 2307/54; B32B 2307/5825; B32B 2307/7163; B32B 2307/72; B32B 2307/7242

(57) ABSTRACT

A biaxially oriented cavitated PHA-rich composite film comprises a PHA-rich core layer and a first outer skin layer and a second outer skin layer. The core layer comprises a PHA resin at an amount of more than 50 wt % of a total weight of the polymeric resin in the core layer and a modifier X, the modifier X includes PLA resins and PLA copolymers and at least one mineral inorganic cavitating agent; the first outer skin layer comprises a PLA resin at an amount less than 50 wt % of the total weight of the outer layer and biopolymers comprising PHA resins or PBSA resins or PCL resins or mixture thereof. The PHA-rich composite film shows a reduced film density and higher yield as well as low light transmission rate.

### FIELD OF THE INVENTION

This invention relates to a biaxially oriented cavitated PHA-rich compostable film. The cavitated PHA-rich composite film with home compostability provides a reduced film density and opacity while maintaining fit-for-use properties required for packaging and label films.

### BACKGROUND OF INVENTION

Recently, an increasing interest in biodegradable and compostable for the application of packaging and labels has been strongly developing. Compostable materials based on biologically derived polymers are being attracting due to concerns with plastic pollution, renewable resources, raw materials, and greenhouse gas generation. Bio-based plastics are believed to help reduce reliance on petroleum-based plastics, reduce production of greenhouse gases, and eliminate plastic pollution. Products made from bio-based plastics could be biodegradable or compostable through formulating selected biomaterials.

Both petroleum-based BOPP and bio-based BOPLA films having high transparency, high clarity and high gloss as well as high Young's modulus are good candidate materials for the applications of packaging and labels. The disadvantage of BOPP film is its petroleum-based source, and the disadvantage of BOPLA film is its super high stiffness and high composting temperature. BOPLA film can only be composted at industrial composting environment under a controlled temperature of about 58±2° C. (ASTM D 5338-15). PLA film is not home compostable.

Polyhydroxyalkanoates (PHAs) are a group of renewable biodegradable polyesters that are synthesized by mainly microorganisms from renewable sources including sugars obtained from lignocellulosic biomasses, agricultural wastes, starches, and vegetable oils; PHAs are completely biodegradable and converted into CO₂ and H₂O in soil and oceans per AS 5810-2010 standard. PHAs are certified compostable bioplastics that could be used for making compostable products, such as containers, packaging films, and labels. However, PHA resins exist a few disadvantages including their poor mechanical properties, poor thermal stability, long crystallization time, high production cost as well as incompatibility with conventional thermal processing techniques. Those drawbacks have limited their competition with traditional synthetic plastics or their application as ideal bioplastics. To overcome these drawbacks, PHAs must be modified with other bioplastics to meet the performance required for specific applications.

PLA resins are considered one of good candidates used to modify PHA resins for improving processability and stiffness, but the compostability of modified PHA/PLA alloy materials is maintained.

A PHA-rich composite is formulated to meet the specific requirements addressed herein. PHA-rich composite is defined as that the content of PHAs is higher than 50 wt % of the total weight of the composite, and a PHA-rich composite film has a core layer (base layer) comprising PHA resins not less than 50 wt % of the total weight of the polymeric resins in the core layer.

It is obvious that PHA-rich composite films have a density at about 1.24 g/cm³, which is higher than of BOPP film at about 0.905 g/cm³. This means that a PHA-rich composite film of the same thickness as a BOPP film will have a much lower yield—a term commonly used in the industry denoting a unit area per unit weight of the film—than the BOPP film. The difference in yield is due to the density difference between bioplastics and PP resins. Thus, this significantly reduces the yield of PHA-rich composite film, compared to that of a BOPP film with the same thickness, resulting in that PHA-rich composite film is much more costly to a BOPP film even if the unit price and productivity of making PHA-rich composite film is about the same as that of BOPP film.

Cavitation is often used to make a film more cost competitive. Cavitated film has a reduced film density due to empty voids inside film structure relative to a non-cavitated film. In addition, opaque or white opaque films are often desirable for certain applications of packaging and labels for aesthetic reasons. Cavitated films provide a different appearance to the inside of the package when opened by the consumer (white look). A high opacity is also usually desirable so as to provide hiding power over the product, printing, or other laminate films; light or UV protection; or brighter white appearance. Especially, the cost of biomaterials is high, cavitation can reduce product cost using inexpensive cavitating agent to achieve high yield.

EP U.S. Pat. No. 1,385,899 describes a method of making biaxially oriented PLA film with cavitation by adding 0.5-30 wt % of a cyclic olefin copolymer (COC) having a Tg of 70-270° C. in the core layer. The film has vacuole-like cavities and a density of less than 1.25 g/cm³. The film density is still very high suggesting a poor efficient of cavitation. In addition, COC polymer is a petroleum-based polymer, which is not sustainable.

U.S. Pat. No. 8,916,080B2 describe a method of making biaxially oriented PLA film with matte and opaque appearance by adding a single matting agent consisting of antiblock particles in an amount of 0.03-0.2 wt % of the core layer and by using high orientation rate in transverse direction (TD) up to about 8 to 10.6 times. The matte PLA film has a haze of about 11% and a light transmission rate about 41 to 52% and a high film density at about 1.20 g/cm³ (as shown in Table 1). High stretching rate in transverse direction is impractical due to the characteristics of biopolymer which is a type of polyester resin. For a better matte finish, it is preferred to have a higher haze and lower light transmission obtained in lower TD stretching rate.

U.S. Pat. No. 9,637,605B2 describes a method of effectively making biaxially oriented PLA film with cavitation using phosphonic metal salt as cavitating agent. The salt cavitating agent gave more efficient cavitation than other types of such as polymeric or inorganic cavitating agents at the same levels of loading. The salt particles under processing condition could develop finer and well-dispersed voids so that cavitated PLA film could maintain superior tensile strength and mechanical properties. However, the invented film did not demonstrate a good density reduction using phosphonic metal salt and the invented film only has a maximum haze of about 76%. The inorganic cavitating agent CaCO3 masterbatch (MB) has about 40 wt % CaCO3 in PLA4032D resin, at about a loading level of 40 wt % CaCO3 MB in the core, the active CaCO3 loading is about at 16 wt %, resulting in a cavitated film density at about 1.02 g/cm³, but the haze of the film was high CaCO3 loading is only about 92%.

USPTO Pub. No.: US2024/0066848A1 describes a method of making biaxially oriented PHA-rich composite film comprising a blend of PHA and PLA resins in the core layer with improved heat seal properties and mechanical properties. Although the invented PHA-rich composite film has high haze and low gloss, the biaxially oriented composite film was not cavitated, therefore the film density was not reduced.

Therefore, there is a practical need for the preparation of a biaxially oriented PHA-rich home compostable film with cavitation to reduce film density and increase yield for cost reduction, retaining high haze and low light transmission using cavitating agents.

In general, cavitation is a cost-effective method to reduce product cost and achieves high opacity and low film density. However, a drawback of cavitation is impairment of heat sealing, tensile and tearing properties as the presence of voids which become weak points in the core layer of a film.

There is a need of balancing cavitation and film properties using PHA and PLA resins with high mechanical strengths to produce cavitated PHA-rich composite films which are fit-for-use for packaging and label applications while maintaining high opacity and high yield and lower product cost also retaining the sustainability through rendering the inventive films biodegradable and compostable.

### SUMMARY OF INVENTION

This invention demonstrates a method of making a fit-for-use cavitated PHA-rich composite film using specific biopolymers including PHA, PLA, PBSA and PCL resins with desirable resin properties.

Inventors demonstrate the preparation of a biaxially oriented PHA-rich composite film with cavitation for the application of packaging films and printing labels such as pressure sensitive labeling (PSL) with improved film density and yield using cavitating agents at a relative low loading level so that mechanical properties and heat sealing performance can be maintained at a desirable range of the properties required for the final application.

In an embodiment, a biaxially oriented film comprising a core layer and an outer layer, wherein the core layer comprises two or more polymers that are not miscible but compatible, the core layer is a PHA-rich core layer comprising polyhydroxyalkonate (PHA) resin more than 50 wt % of a total weight of the polymeric resin in the core layer, wherein the outer layer comprises polylactic acid resin less than 50 wt % of a total weight of the outer layer, wherein the film is a cavitated film comprising a cavitation agent in an amount about 2 to 30 wt % of the total weight of the core layer, wherein the outer layer comprise a polymer blend Y, wherein a density of the core layer and the outer layer without the cavitation agent is more than 1.2 gm/cm³, and a density of the biaxially oriented film having cavitation agent in the core layer is less than 1.1 gm/cm3.

In an embodiment, the cavitation agent comprises calcium carbonate and/or titanium oxide. In an embodiment, the core layer further comprises a non-PHA modifier X.

In an embodiment, the non-PHA modifier X comprises one or more resins having glass transition temperatures Tg≤60° C.

In an embodiment, the polymer blend Y comprising TUV certified home compostable polymeric resins at an amount more than about 50 wt %, such as about 55 wt %, about 60 wt %, about 70 wt %, about 80 wt %, about 90 wt % or more.

In an embodiment, the polymer blend Y comprises one or more resins having glass transition temperatures Tg≤10° C.

In an embodiment, the biaxially oriented film is biodegradable as per ASTM D 5338-15 and home compostable as per AS 5810-2010 standard.

In an embodiment, the PHA resin in the core layer has a melting temperature of about 145° C. to 180° C. and a crystallinity higher than 35%.

In an embodiment, the cavitating agent in the core layer comprises organic and inorganic particles with a particle size of about 0.1 microns to 10 microns.

In an embodiment, the inorganic particles comprise nanoclay, talc, CaCO3 or TiO2 or mixtures thereof.

In an embodiment, the film further comprises an additional outer layer opposite to a first outer layer such that the core layer is sandwiched between two outer layers.

In an embodiment, the outer layer is a heat sealant layer.

In an embodiment, the outer layer is configured for metallizing, printing, coating and/or lamination.

In an embodiment, the film further comprises one or more tie layers between the core layer and the outer layer.

In an embodiment, the polymer blend Y comprises a PLA resin, PHA resin, PBSA resin and PCL resin or mixtures thereof.

In an embodiment, the haze of biaxially oriented film is more than 45% as measured according to ASTM D1003, such as more than 50%, 60%, 70%, 80% or more

In an embodiment, a composition of a second outer layer is same or different than a composition of a first outer layer.

In an embodiment, the outer layer further comprises an amount of antiblock particles with a spherical size of about 2 μm to 6 μm.

In an embodiment, the thickness of the composite film is about 10 μm to about 80 μm.

In an embodiment, the thickness of the composite film is about 15 μm to about 50 μm.

In an embodiment, the outer layer has a thickness of about 1 μm to about 5 μm. In an embodiment, the outer layer has a thickness of about 1 μm to about 3 μm.

In an embodiment, a biaxially oriented film comprising a core layer and an outer layer, wherein the core layer comprises two or more polymers that are not miscible but compatible, the core layer is a PHA-rich core layer comprising polyhydroxyalkonate (PHA) resin more than 50 wt % of a total weight of the polymeric resins in the core layer, wherein the outer layer comprises polylactic acid resin less than 50 wt % of a total weight of the outer layer, wherein the film is a cavitated film comprising a cavitation agent in an amount about in an amount about 2 to 30 wt % of the total weight of the core layer, wherein a density reduction of the cavitated film with respect to the density of a non-cavitated biaxially oriented film having same polymer composition but without the cavitation agent, is about 5% or more.

In an embodiment, the density of the cavitated film is less than 10% to 25% compared to the density of non-cavitated biaxially oriented film. In an embodiment, density of the cavitated film vs. non-cavitated film having similar composition as that of the cavitated film could be less than about 5%, 7%, 10%, 15%, 20%, 25% or more

In an embodiment, the outer layer comprises a polymer blend Y comprising one or more resins having glass transition temperatures Tg≤10° C.

In an embodiment, one or more resins of the polymer blend Y comprises PHA, polybutylene succinate (PBS) or polybutylene succinate-co-adipate (PBSA) or polycaprolactone (PCL) or mixture thereof.

In an embodiment, the polymer blend Y further comprises a predetermined amount of a processing aid, a chain extender, a nucleating agent, a biodegradable promoter, a plasticizer, antiblock particles, inorganic particles and/or slip additives or mixtures thereof.

In an embodiment, the outer layer comprises TÜV-certified home compostable resins at least about 50 wt % of the total weight of the outer skin layer.

In an embodiment, the PLA resin comprises a semi-crystalline PLA resin, an amorphous PLA resin, PLA copolymers or mixtures.

In an embodiment, the weight of the outer layer polymer is an amount of about 1 to 25 wt % of the total weight of the core layer.

In an embodiment, the core layer comprises a non-PHA modifier X comprising one or more resins having glass transition temperatures Tg≤60° C.

In an embodiment, the PHA resin in the core layer includes a semi-crystalline PHA resin.

In an embodiment, the PHA resin in the core layer has a melting temperature of 145 to 180° C. and a crystallinity higher than about 35%, such as 40%, 50% or more.

In an embodiment, the non-PHA modifier comprises a PLA resin.

In an embodiment, a biaxially oriented film comprising a core layer and an outer layer, wherein the core layer comprises two or more polymers that are not miscible but compatible, the core layer is a PHA-rich core layer comprising polyhydroxyalkonate (PHA) resin more than 50 wt % of a total weight of the core layer, wherein the outer layer comprises polylactic acid resin less than 50 wt % of a total weight of the outer layer, wherein the film is a cavitated film comprising a cavitation agent in an amount about in an amount about 2 to 30 wt % of the total weight of the core layer, wherein a light transmission of the biaxially oriented film is less than 75% of transmission of a visible light from an emitter to a sensor of a light transmission measurement device.

In an embodiment, biaxially oriented film comprising a core layer and an outer layer,

In an embodiment, the core layer comprises two or more polymers that are not miscible but compatible, the core layer is a PHA-rich core layer comprising polyhydroxyalkonate (PHA) resin more than about 50 wt % of a total weight of the polymeric resins in the core layer, wherein the outer layer comprises polylactic acid resin less than 50 wt % of a total weight of the outer layer, wherein the film is a cavitated film comprising a cavitation agent in an amount about in an amount about 2 to 30 wt % of the total weight of the core layer; wherein the biaxially oriented film is biodegradable as per ASTM D 5338-15 and home compostable as per AS 5810-2010 standard.

In an embodiment, biaxially oriented film comprising a core layer and an outer layer, wherein the core layer comprises two or more polymers that are not miscible but compatible, the core layer is a PHA-rich core layer comprising polyhydroxyalkonate (PHA) resin, wherein the outer layer comprises polylactic acid resin, wherein the film is a cavitated film comprising a cavitation agent in an amount greater than 2 wt % of the total weight of the core layer; wherein the biaxially oriented film is biodegradable as per ASTM D 5338-15 and home compostable as per AS 5810-2010 standard wherein an amount of starch if present in the biaxially oriented film is less than 5 wt %. In an embodiment, if the film contains starch than it is less than 5 wt. %, 2 wt. % or less.

In an embodiment, PHAs are modified in the core layer of a film by using PLA resins and PLA copolymers.

In an embodiment, cavitating agent CaCO3 is added into the core layer of the film at a level of about 2 to 30 wt % of the weight of the core layer. CaCO3 powder with a particle size of about 0.2 to 10 μm was made into a masterbatch in semi-crystalline PLA resin at a loading level of about 30 to 50 wt % in PLA carrier resin.

An embodiment relates to a multi-layer composite film comprising a PHA-rich core layer (B), a first outer skin layer (A), and a second outer skin layer (C); wherein the PHA-rich core layer comprises PHA resin and non-PHA modifier X, wherein the core layer has an amount of PHA resin more than 50 wt %, preferably, more than 60 wt %, and more preferably more than 70 wt % of the total weight of the polymeric resins in the core layer; wherein the non-PHA modifier X has a glass transition temperature of Tg≤60° C.; wherein an amount of the modifier X is less than 50 wt % of the total weight of the core layer; wherein the first outer skin layer comprises a polymer blend Y including PLA, PHA, PBSA and PCL resins; wherein the film is sequentially oriented in machine direction (MD) for 2 to 3.5 times and then in transverse direction (TD) for 3 to 5.5 times or the film is simultaneously oriented in both machine and transverse direction for a similar stretching ratio.

In an embodiment, a biaxially oriented film comprising a core layer and an outer layer, wherein the core layer comprises two or more polymers that are not miscible but compatible, the core layer is a PHA-rich core layer comprising polyhydroxyalkonate (PHA) resin more than about 50 wt % of a total weight of the polymeric resins in the core layer, wherein the outer layer comprises polylactic acid resin less than 50 wt % of a total weight of the outer layer, wherein the film is a cavitated film comprising at least one cavitation agent in an amount about 2 to 30 wt % of the total weight of the core layer wherein a density of the core layer and the outer layer without the cavitation agent is more than 1.20 gm/cm³, and a density of the biaxially oriented film having cavitation agent in the core layer is less than 1.10 gm/cm³.

In an embodiment, a biaxially oriented film comprising a core layer and an outer layer, wherein the core layer comprises two or more polymers that are not miscible but compatible, the core layer is a PHA-rich core layer comprising polyhydroxyalkonate (PHA) resin more than 50 wt % of a total weight of the polymeric resins in the core layer, wherein the outer layer comprises polylactic acid resin less than about 50 wt % of a total weight of the outer layer, wherein the film is a cavitated film comprising a cavitation agent in an amount about in an amount about 2 to 30 wt % of the total weight of the core layer, wherein a light transmission of the biaxially oriented film is less than 75% of transmission of a visible light from an emitter to a sensor of a light transmission measurement device.

In an embodiment, a biaxially oriented film comprising a core layer and an outer layer, wherein the core layer comprises two or more polymers that are not miscible but compatible, the core layer is a PHA-rich core layer comprising polyhydroxyalkonate (PHA) resin more than 50 wt % of a total weight of the polymeric resins in the core layer, wherein the outer layer comprises polylactic acid resin less than 50 wt % of a total weight of the outer layer, wherein the film is a cavitated film comprising a cavitation agent in an amount about 2 to 30 wt % of the total weight of the core layer; wherein the biaxially oriented film is biodegradable as per ASTM D 5338-15 and home compostable as per AS 5810-2010 standard.

In an embodiment, a biaxially oriented film comprising a core layer and an outer layer, wherein the core layer comprises two or more polymers that are not miscible but compatible, the core layer is a PHA-rich core layer comprising polyhydroxyalkonate (PHA) resin, wherein the outer layer comprises polylactic acid resin, wherein the film is a cavitated film comprising a cavitation agent in an amount greater than about 2 wt % of the total weight of the core layer; wherein the biaxially oriented film is biodegradable and home compostable as per AS 5810-2010 standard wherein an amount of starch if present in the biaxially oriented film is less than 5 wt. %.

In an embodiment, wherein the PHA resin in the core layer includes semi-crystalline PHA resins such as PHB, PHBV, PHB-co-3HV, PHB-co-3HHx, PHB-co-3HO, and PHB-co-4HHx or mixtures thereof.

In an embodiment, the PHA resin in the core layer has a crystallinity higher than 35 wt % determined by the method of differential scanning calorimetry (DSC).

In an embodiment, the total crystallinity of the core layer including the crystallinity of PHA and PLA resins and other bioplastics is higher than about 35 wt % of the total weight of the polymeric resins in the core layer.

In an embodiment, the modifier X comprises PLA resins and PLA copolymers with a glass transition temperature of 40° C.≤Tg≤60° C.

In an embodiment, the modifier X optionally comprises a desirable amount of low Tg flexible biopolymers including PBS, PBSA, PCL, PBAT, and other biodegradable polymers or mixtures thereof with a glass transition temperature of Tg≤10° C. to provide hermetic seal properties by reducing SIT and increasing plateau seal strength.

In an embodiment, the modifier X includes PLA resin at an amount of less than about 50 wt % of a total weight of the core layer. Such as less than 40 wt %, 30 wt %, 20 wt %, 10 wt % or less wt % of a total weight of the core layer.

In an embodiment, the modifier X further comprises an amount of less than about 5 wt % petroleum-based polymeric modifier with a glass transition temperature of Tg≤10° C.

In an embodiment, the core layer further optionally comprises a processing aid, a chain extender, a nucleating agent, a biodegradable promoter, a plasticizer, organic or inorganic particles and/or slip additives or mixtures thereof,

In an embodiment, the core layer comprises organic or inorganic particles as cavitating agent for the purpose of forming cavitation.

In an embodiment, the organic particles comprise incompatible particles comprising polypropylene (PP) and cyclic olefin copolymer (COC) resins.

In an embodiment, the inorganic particles comprise nanoclay, talc, calcium carbonate CaCO₃ or titanium oxide TiO₂ or mixtures thereof with a particle size in the range of 0.2 to 10 microns.

In an embodiment, the film is cavitated in the core layer with loaded cavitation agent at an amount of about 0.5 wt %, 2 wt %, 5 wt %, 8 wt %, 12 wt %, 16 wt %, 20 wt %, 25 wt %, to 30 wt % of the total weight of the core layer.

In an embodiment, the film is pigmented with added pigments at an among of about 2 wt %, 5 wt %, 8 wt % to 10 wt % of the total weight of the core layer.

In an embodiment, the pigment in the core layer is TiO₂ pigment.

In an embodiment, the first outer skin layer (A) comprises a polymer blend Y comprising PLA, PHA, PBSA and PCL resins.

In an embodiment, the polymer blend Y in the first outer skin layer (A) comprises a PLA resin at an amount not more than 40 wt % of the total weight of the first outer skin layer.

In an embodiment, the PLA resin in the first outer skin layer comprises semi-crystalline PLA resin, amorphous PLA resin and PLA copolymers or mixtures thereof with a melt flow index of 3 to 15 g/10 min. at the test condition of 190° C. and 2.16 Kg.

In an embodiment, the PHA resin in the first outer skin layer is about 0 wt % to about 95 wt % of the total weight of the outer skin layer.

In an embodiment, the PBSA resin in the first outer skin layer is about 0 wt % to about 95 wt % of the total weight of the outer skin layer.

In an embodiment, the PCL resin in the first outer skin layer is about 0 wt % to about 35 wt % of the total weight of the outer skin layer.

In an embodiment, the polymer blend Y in the first outer skin layer further comprises a processing aid, a chain extender, a nucleating agent, a biodegradable promoter, a plasticizer, antiblock particles, inorganic particles and/or slip additives or mixtures thereof,

In an embodiment, the weight of the first outer skin layer polymer is an amount of about 1.0 wt % to 25 wt % of the total weight of the core layer.

In an embodiment, the composite film comprises only a core which is essentially a monolayer of the base film.

In an embodiment, the composite film comprises a second outer layer.

In an embodiment, the composite film comprises a core layer, a first outer layer, and a second outer layer.

In an embodiment, the second outer skin layer comprises the same materials as the first outer skin layer.

In an embodiment, the second outer skin layer comprises materials different from the first outer skin layer.

In an embodiment, the first outer skin layer comprises the same materials as the core layer.

In an embodiment, the first outer skin layer comprises materials different from that of the core layer.

In an embodiment, wherein the composite film optionally comprises either one or two tie-layers which is located between the core layer and the two outer skin layers.

In an embodiment, the outer skin layers comprise an amount of antiblock particles with a spherical size of about 2 to 6 μm.

In an embodiment, a loading of the antiblock particles in the outer skin layers is in the range of 100 to 5000 ppm of a total weight of the outer skin layers.

In an embodiment, the outer skin layers comprise a migratory slip additive.

In an embodiment, a loading of the migratory slip additive is in the range of 500 to 5000 ppm of a total weight of the outer skin layers.

In an embodiment, the film is configured to be a print film has the core layer comprising migratory particles in an amount of 500 to 1000 ppm.

In an embodiment, the outer skin layer is either a layer of receiving print ink, adhesives, metal deposition or coating.

In an embodiment, the composite film comprises a heat sealable layer.

In an embodiment, the composite film comprises no heat sealable layer.

In an embodiment, the thickness of the composite film is about 10 μm to about 80 μm.

In an embodiment, the thickness of the film is about 15 μm to about 50 μm.

In an embodiment, the outer skin layers have a thickness of about 1 μm to about 5 μm.

In an embodiment, the skin layers have a thickness of about 1 μm to about 3 μm. In an embodiment, the skin layers have a thickness of about 1 μm to about 2 μm.

In an embodiment, the composite film could essentially be used as home compostable packaging and label materials.

In an embodiment, the core layer comprises TUV-certified home compostable bioplastics at an amount more than 50 wt %, preferably more than 60 wt %, more preferably more than 70 wt % of the total weight of the polymeric resins in core layer.

In an embodiment, the outer skin layers comprise TUV-certified home compostable bioplastics at an amount more than 60 wt %, more preferably more than 70 wt % of the total weight of the outer skin layers.

In an embodiment, discloses the method of making a biaxially oriented PHA-rich composite film suitable for the application of packaging and label in which high mechanical properties such as tensile strength and Young's modulus are required for the final products.

In an embodiment, the invention provides a method of making PHA-rich composite film with cavitation wherein the heat sealing and mechanical properties can be maintained.

In other instances, the film may comprise 3-layers, 4-layers, 5-layers or more than 5-layers. For example, the film may be a multi-layer film with one or more of the layer being a tie layer.

### BRIEF DESCRIPTION OF THE FIGURES

The accompanying drawings, which are included to provide further understanding of the present invention disclosed in the present disclosure and are incorporated in and constitute a part of this specification, illustrate aspects of the present invention and together with the description serve to explain the principles of the present invention. In the drawings:

FIG. 1: SEM cross-sectional image of a biaxially oriented cavitated PHA-rich composite film made in comparative Example 1 (CEx. 1).

FIG. 2: SEM cross-sectional image of a biaxially oriented cavitated PHA-rich composite film made in comparative Example 2 (CEx. 2).

FIG. 3: SEM cross-sectional image of a biaxially oriented cavitated PHA-rich composite film made in comparative Example 3 (CEx. 3)

FIG. 4: Comparison on the heat seal curves of the cavitated and non-cavitated PHA-rich composite films.

FIG. 5: Comparison on the hot tack curves of the cavitated and non-cavitated PHA-rich composite films.

FIG. 6: Cross-section view of a biaxially oriented cavitated PHA-rich composite film according to an embodiment of the invention.

### DETAILED DESCRIPTION

### Definitions and General Techniques

For simplicity and clarity of illustration, the figures illustrate the general manner of construction, and descriptions and details of well-known features and techniques may be omitted to avoid unnecessarily obscuring the present disclosure. Additionally, elements in the figures are not necessarily drawn to scale. For example, the dimensions of some of the elements in the figures may be exaggerated relative to other elements to help improve understanding of embodiments of the present disclosure. The same reference numerals in different figures denote the same elements. The methods and techniques of the present invention are generally performed according to conventional methods well known in the art and as described in various general and more specific references that are cited and discussed throughout the present specification unless otherwise indicated. The nomenclatures used in connection with, and the procedures and techniques of embodiments herein, and other related fields described herein are those well-known and commonly used in the art.

The following terms and phrases, unless otherwise indicated, shall be understood to have the following meanings.

“Polymer” is a macromolecule compound prepared by polymerizing monomers of the same or different type. Polymer includes homopolymers, copolymers, terpolymers, tetrapolymers, and so on. “Homopolymer” is a polymer by polymerizing one monomer and has the same repeating unit in the polymer chain. “Copolymer” is a polymer derived from more than one species of monomers or comonomers. “Terpolymer” is a polymer made by polymerizing three different monomers and “Tetrapolymer” is a polymer by polymerizing four different monomers, and so on.

In an embodiment, polymers could include additional additives. The polymer is interchangeable used as “resin”.

“Biaxially oriented film” is a film that is stretched in both machine and transverse directions, producing molecular chain orientation sequentially or simultaneously in two directions. A biaxially oriented film has much higher tensile strength and Young's modulus in comparison with a non-oriented co-extruded film or a blown film which is mainly oriented in machine direction. In addition, a blown film can also have high heat shrinkage in machine direction. The biaxially oriented film could be a single layer or multi-layer composite film. A multi-layer composite film could be without limitation 2 layered, 3 layered, 5 layered, or more.

“Biodegradable Bioplastics” or “Biodegradable Film” or “Biodegradable label film” or “Compostable Composite Film” or “Compostable label film” or similar refer to polymeric materials that are ‘capable of undergoing decomposition into carbon dioxide, methane, water, inorganic compounds, or biomass in which the predominant mechanism is the enzymatic action of microorganisms, that can be measured by standardized tests, in a specified period of time, reflecting available disposal condition’. In an embodiment, more than about 50%, 60%, 70%, 80%, 90% of the film could be biodegraded by the microbial action per ASTM D 5338-15. In an embodiment, the film could be fully degraded by the microbial action.

In an embodiment, the biodegradable film has a home composting property as described by AS 5810-2010 standard.

Other equivalent certifications or regulatory authorities, for the biodegradability and/or disintegration standards are ISO 20200 or various similar standards for home compostability (e.g., NF T51-800 (2015); or the OK Compost Home Certification scheme of TÜV Austria Belgium).

“Semi-crystalline” or “semicrystalline” refers to a polymer that exhibits highly organized and tightly packed molecular chains. “Semi-crystalline” may be simplified as “crystalline” as in comparison with “amorphous”. The crystalline regions are called spherulites and can vary in shape and size with amorphous regions existing between the crystalline regions. As a result, this highly organized molecular structure has a defined melting temperature point.

“Crystallinity” refers to the degree of highly organized order structure excluding the fraction of amorphous phases in a resin. Typically, a semi-crystalline resin has a degree of crystallinity in the range of from 10 wt % to 80 wt % of the total weight of the resin.

The crystallinity of a PHA resin is calculated from the heat of fusion of the PHB resin, and the heat of fusion ΔH° is about 146 J/g for perfect PHB crystals (Journal of Biomaterials and Nanobiotechnology 2011; 2; 301 to 310, herein reference is listed for convenience).

The crystallinity of PLA resins is calculated from the heat of fusion 93.6 J/g for 100% crystalline PLA crystals (polylactic acid) (J Polym Environ 2001; 9:63-84, herein reference is listed for convenience).

“Total crystallinity” refers to the crystallinity of a polymer blend or composite containing more than one component. The degree of the crystallinity of each component can be measured by using differential scanning calorimetry (DSC). The degree of the crystallinity of a polymer blend or composite can also be determined by using DSC experiment. If a composite comprises 40 wt % Y1000P (PHBV), 30 wt % BP330-05 (PHB-co-3HHx), and 30 wt % PLA4043 (PLA) resins, wherein the crystallinity of Y1000P, BP330-05 and PLA4043D is about 73 wt %, 38 wt %, and 41 wt %, respectively. The total crystallinity of the composite is about 40.6 wt % which can be obtained from calculation.

“Amorphous resin” has a randomly ordered molecular structure which does not have a sharp melting temperature point. Such a resin often softens or solidifies as its temperature is changed to above Tg or below Tg.

“Glass transition temperature, Tg” is a thermal property associated with the long-range segmental mobility of polymer chains. As the temperature increases above Tg, a resin starts softening; as the temperature drops below Tg, the resin starts solidifying.

Tg governs the rigidity, toughness and flexibility of a polymer or polymer composite in a specific temperature range. Under ambient temperature condition, a polymer film with a Tg higher than ambient temperature, it is rigid, otherwise it is flexible as it has a Tg below ambient temperature. Either DSC or DMA (dynamic mechanical analysis) can be used to determine the Tg of polymers, polymer blends, composites, and multilayer plastic films.

“Low Tg flexible biopolymers” in the invention refer to those biopolymers have a Tg less than 10° C., including PBSA, PBS and PCL, PBAT, and PHA resins, but PHB and PHBV are excluded. Although PHB or PHBV biopolymers have a Tg lower than 10° C., they are rigid biopolymers due to their high crystallinity.

“Modifier” refers to materials that are added into the resin to improve the properties of a biaxially oriented composite film such as but not limited to improving mechanical strength (flexibility, modulus, tensile strength, elongation, etc.), thermal stability, biodegradability, compostability, optical properties, and surface properties, heat sealing properties and so on. In an embodiment, modifier could be added in the resin during an appropriate step of polymerization, melt compounding, dry blending and coextrusion processes at a desirable amount.

“Modifier X” is a non-PHA based modifier used to modify the core layer. Modifier X comprises biopolymers having a glass transition temperature of Tg≤60° C. It includes for example but not limited to PBS, PBSA, PCL, PBAT, PLA, and PLA copolymers such as PLA-co-GA, PLA-co-3HP, and PLA-co-8-CL copolymers.

“Polymer blend Y” is a mixture of biopolymers in the outer skin layer. The polymer blend Y comprises PLA resins, PHA resins, PBS resins, PBSA resins, PCL resins, or other biodegradable polymers or mixtures thereof.

“PHA-rich” is defined when the content of PHAs is more than 50 wt % in the total weight of the layer. Therefore, a PHA-rich composite film has a core layer comprising PHA resins not less than 50 wt % of the total weight of the core layer.

“PLA resin” is polymerized from a racemic mixture of L- and D-lactides with the level of (L) and (D) monomers being variable. The crystallinity of PLA resins (including L-dominated PLLA and D-dominated PDLA) can be controlled by the ratio of L and D monomers in PLA chain structure.

“Peak melting temperature” refers to the average melting temperature (Tm) of the crystallites of a semi-crystalline polymer. The Tm of a semi-crystalline polymer is obtained by measuring a polymer sample well annealed at its crystallization temperature using DSC at a heating rate of 10° C./min.

“Shrink film” refers to a plastic film which shrinks tightly over whatever it is covering due to high heat shrinkage rate when heat is applied to it. Shrink film can be used for either packaging film or shrinkable composite film. Usually, a shrink film has a percentage of the amount of shrink measured in both the machine direction (MD) and the transverse direction (TD) above 20%.

“Non-shrink film” usually refers to a plastic film which is stretchy and requires no heat application. Stretching tension and cling of a plastic film provide tightness required for packaging.

“Heat resistant film” refers to a plastic film which has heat shrinkage rate less than 10% in both machine direction and transverse direction when processing heat such as metallizing, printing, coating, laminating or heat sealing is applied to it. The characteristics of heat resistance is required for food packaging as well as label film.

“Miscibility” refers to capability of a mixture to form a single phase over certain ranges of temperature, pressure, and composition. Most pairs of polymers are immiscible (not miscible) with each other.

“Compatibility” is defined as the capability of the individual component substances in immiscible blend to exhibit interfacial adhesion.

“Tie layer” refers to a layer of polymer resins added in a film to provide adhesion between specific polymers or specific functions during the film manufacturing process. Tie resins are often sandwiched between layers to provide film properties such as bonding, or barrier, or hermetic sealing or optical properties so on.

“Film density” is a measure of a plastic film in g/cm³ or kg/m³. Density calculation in plastic film involves measuring the film's mass and volume. The density of LDPE, HDPE and PP films is well known in the range of about 0.91 to 0.94 g/cm³, 0.93 to 0.97 g/cm³, 0.895 to 0.92 g/cm³, respectively; the density of a biaxially oriented polyester film (BOPET) is about 1.4 g/cm³; the density of a biaxially oriented polylactic acid film (BOPLA) is about 1.24 g/cm³.

“Yield” is a measure of a film's coverage per unit of weight. Film density can be used to determine the yield of a plastic film with a designed thickness by calculating the surface area of a unit weight such as in²/lb (square inches per pound) in US standard and m²/kg in metric (or SI) units. Yield calculation depends on film thickness and density. For the same film thickness, a plastic film with a lower film density has higher yield.

In an embodiment, the yield of a cavitated film can be calculated from a basic equation: Film Density (Df) times Film Volume (Vf)=Film Weight (Wf), while Film Volume (Vf)=Film Area (Af) times Film Thickness (Tf). Therefore, the yield of a cavitated film can be determined from equation: Yield=Af/Wf=(1/Df*Tf).

Terms “outer layer” and “outer skin layer” are interchangeably used in the disclosure.

### Cavitation

“Cavitation” refers to a process of the formation of closed voids (or cavities) when the adhesion between a dispersed phase and continuous phase fails during film orientation. The failure in adhesion makes the continuous phase to stretch while the dispersed phase remains the same during stretching. The number of the voids depends on the size of the dispersed particles and the amount of the dispersed phase (cavitating agent) in the continuous phase (biopolymer). In the present invention, the cavitated film does not form continuous open pores in the film structure like that a micropore membrane film does, instead, forms closed voids in the core layer. In an embodiment, some or all voids initiated due to cavitation are separated and discontinuous. In an embodiment, some includes more than 60%, 70%, 80%, 90% or more voids.

In an embodiment, the film is not breathable. Breathable films are permeable to gases due to the presence of open cells throughout its mass or to perforations.

The particle size distribution of the cavitating agent is in the range of about 0.1 to 10 microns and the optimum particle size is about 0.8 to 2.5 microns. The optimum particle diameter for efficient cavitation depends on polymer types and orientation ratios as well as cavitation purpose and film properties required for final products. Conventionally, the continuous polymer phase in the core layer of a cavitated film is a unique polymer such as polypropylene or polyethylene or poly lactic acid.

PHA resin itself alone cannot be used to make a biaxially oriented film for that the processability and mechanical properties of PHA resins do not meet the requirements needed for a biaxially oriented film. After modification with PLA resins or other biopolymers using alloy technology, a process of biaxial orientation can be applied to PHA-rich composite (or alloy) for film making. To form cavitation, voids will be generated in either PHA phase or PLA phase which are compatible and form a continuous phase of polymer matrix.

To reduce the film density and increase the film opacity, the PHA-rich composite film must be cavitated to form voids by adding at least one cavitating agent into the core layer at an amount of about 2 wt % to 30 wt % of the total weight of the core layer. The voids in film structure diffract light, increasing the opacity of the film, and reduce film density. The cavitating agents could be inorganic and organic particles with a particle size of about 0.2 to 10 microns. Preferably, the cavitating agent is inexpensive mineral based inorganic cavitating agents for the sake of the view of cost factor and sustainability.

Without being bound by any theory, it is believed that when the PHA-rich composite film is biaxially oriented, particularly at relatively low rates in machine direction and in transverse direction compared with that of a cavitated BOPP film, cavitation occurs around the mineral particles such as CaCO3 or incompatible polymers such as cyclic olefin copolymer (COC) or polypropylene (PP) within the core layer due to the failure of the adhesion between continuous polymer phase and dispersed particles during stretching.

Examples of suitable mineral based cavitating agent include calcium carbonate (CaCO3), silicas, and talc, preferably, more cost competitive CaCO3 as cavitating agent. Calcium carbonate specific gravity is about 2.7 g/cm³ which is higher than that a general range of about 0.90 to 0.96 g/cm³ for most polyolefins and about 1.24 to 1.26 g/cm³ for most biodegradable bioplastics such as PHA and PLA resins. Therefore, as the efficient of cavitation is low, the film density could be around or higher than 1.24 g/cm³ due to the high specific gravity of CaCO₃. Cavitating agent CaCO₃ masterbatch in PLA carrier resin can be used to prepare a cavitated PHA-rich composite film.

A cavitated film will be physically thicker than a non-cavitated film due to the formation of voids in the core layer. The enhancement in film thickness (compared to that of a non-cavitated film) induced from cavitation is also called “lofting”. The lofting thickness could be adjusted by changing process conditions such as stretching ratios and temperatures, the loading levels of cavitating agent, the particle size and size distribution of cavitating agent, etc., which can influence the void sizes and degree of cavitation. In general, higher orientation ratios and lower processing temperatures will increase such “lofting”.

Although PHA and PLA resins in the core layer are immiscible and phase separated, two biopolymers are chemically compatible due to their similarity in polarity of chemistry. The adhesion between PHA and PLA resins at interphase boundary is very strong so that stretching could not initiate adhesion failure. The continuous polymer phase is an alloy of PHA and PHA, the separated phase is CaCO3 particles. Cavitation can form in either PHA or PLA biopolymer phases, depending on the physical location of the CaCO3 particles before stretching.

The degree of cavitation impacts the density and opacity of the PHA-rich composite film. At a low degree of cavitation, the film has a matte appearance; at a higher degree of cavitation, the film has an opaque appearance. This cavitation has been observed for the cross-section image of the cavitated PHA-rich film using scanning electron microscopy (SEM). The reduction in film density also confirms cavitation. The higher degree of cavitation a film has, the lower density the film should have, leading to a higher yield.

Therefore, aside from the advantages of low light transmission rate and high haze which are designed for the need of optical properties, a cavitated film, with added inexpensive mineral cavitating agent, not only has lower raw materials cost but also has a higher yield due to its low film density.

### Materials and Properties

### PHA Resins

In an embodiment, Polyhydroxyalkanoates (PHA) resin has a copolymer structure of poly((3HB)ₙ-co-(mHZ)₍₁₋ₙ₎), where H=hydroxy; B=butylene; m is the position number of hydroxy group on the carbon chain of alkanoic acid (m=3 or 4 or 5); Z is the alkanoate in the copolymer (Z=Valerate (V), Hexanoate (Hx), Octanoate (O), and Decanoate (D) or mixtures thereof); n is the mole percentage of 3HB and (1−n) is the mole percentage of mHZ in the copolymer structure. The n value of semi-crystalline PHA resins is usually in the range of 85 to 100 mol %, and the (1−n) value is in the range of about 0 to 15 mol %. As (n−1) is higher than 50 mol %, random PHA copolymers might become amorphous. Both the mole percentage (3HB and mHZ) and the structure of mHZ dominate the basic properties of PHA resins, especially, the crystallinity and melting temperature of the PHA resins. As n=1, the PHA resin is a PHB (or P3HB) homopolymer. PHB homopolymer has a Tg about 0 to 10° C. and a melting temperature of 173 to 178° C. It is a very rigid biopolymer due to its high crystallinity (about 80%). PHA resins have a Tg in the range of −44° C.≤Tg≤10° C. and a Tm of in the range of about 120 to 178° C. (Appl. Sci. 2017, 7, 242, herein reference is listed for convenience). Amorphous PHA resins comprise a high mole ratio of mHZ monomer so that the PHA copolymers has a Tg less than ≤−10° C., they are very rubbery biopolymers. Common engineering PHA biopolymers include PHB, PHBV, PHB-co-3HHx, PHB-co-4HHx, PHB-co-3HO, and PHB-co-3HD.

Example of PHB (or P3HB) homopolymer resins includes Phabuilder PHAlife™ BP3000G, a homopolymer of 3-hydroxybutyrate. The PHB resin has a melting temperature of about 175° C. and a high crystallinity about 56% according to the data obtained from differential scanning calorimetry (DSC) experiment. BP3000G has a glass transition temperature of about 3° C. and a melt flow index 3 to 10 g/10 min. at the test condition of 185° C. and 2.16 Kg, and a density of 1.25 g/cm³. BP3000G is also a very rigid biopolymer due to its high crystallinity.

Example of PHBV resins include TianAn Enmat™ Y1000P, poly(3-hydroxybutyrate-co-3-hydroxyvalerate) (PHB-co-3HV or PHBV). An amount of from about 0.5 to 1 mol % 3hydroxyvaleric acid comonomer (3HV) obtained from petroleum-based chemicals as a precursor was added into feedstock in fermentation process to synthesize the copolyester of PHBV. The short side chain (ethyl group CH₂CH₃) of 3HV can be incorporated into PHB crystals, leading to a high melting point of 173° C. and a high crystallinity (73%) according to the data obtained from differential scanning calorimetry (DSC) experiment. Y1000P has a glass transition temperature of about 2° C. and a melt flow index 8 to 15 g/10 min. at the condition of 190° C. and 2.16 Kg, and a density of 1.25 g/cm³. Y1000P is a very rigid biopolymer due to its high crystallinity. The PHBV copolymer performs the same as the PHB homopolymer due to their similarity of polymer chain structure in solid state.

A reversed extrusion temperature profile is preferably needed for extruding the PHB and PHBV resins for the sake of preventing from significant thermal degradation. Preferably, an amount of biopolymers with lower Tm, amorphous biopolymers, and plasticizers or mixtures thereof could be blended with PHBV or PHB resin in the core layer in extrusion to facilitate PHB or PHBV melting and eliminate its thermo-mechanically induced degradation.

Commercialized PHA copolymers mainly comprise 85 to 100 mol % of 3-hydroxy butyric acid monomer and 0 to 15% other comonomers. PHA copolymers include P3HB-co-3HHx which is a copolymer of 3-hydroxybutyrate and 3-hydroxyhexanoate; P3HB-co-4HHx which is a copolymer of 3-hydroxybutyrate and 4-hydroxyhexanoate; P3HB-co-4HB which is a copolymer of 3-hydroxybutyrate and 4-hydroxybutyrate; P3HB-co-3HO which is a copolymer of 3-hydroxybutyrate and 3-hydroxyoctanoate (3HO). Example of P3HB-co-4HB includes PHAlife™ BP3430G which is a copolymer of 3-hydroxybutyrate and 4-hydroxybutyrate. BP3430G has a melting temperature of 173° C. and a crystallinity of 18% according to DSC experiment data and melt flow of about 7 g/10 min. at the test condition of 180° C. and 2.16 Kg.

In an embodiment, the optimal crystallinity of PHA resins used in the core layer in the invention is higher than 35% to improve rigidity and Young's modulus. Preferably, optimal melting temperature of the PHA resins is higher than 145° C. It has been reported that PHA resins with a high percentage of side chains longer than three carbons including side chains 3-hydroxyhexanoate (3HHx), 3-hydroxyoctanoate (3HO), and 3-hydroxydecanoate (3HD) have a crystallinity in the range of about 35 to 42%, those PHA resins are flexible due to the characteristics of glass temperatures in the range of about-3 to 3° C., those PHA resins have Young's modulus at the levels of oriented HDPE films, which is much lower than that of BOPP film used in packaging and label film.

It has been noted that biaxially oriented HDPE film is insufficient in both tensile strength and Young's modulus to replace BOPP packaging and label film materials in the market. Optimal Young's modulus for desirable packaging and label film needs to reach or close the modulus levels of BOPP films. In comparison, the crystallinity of homopolypropylene resins used in the market is about in the range of 60 to70 wt %, which is much higher than that of PHA resins (35 to 42%) with longer side chains. In addition, the melting temperature of homopolypropylene is in the range of 160 to 170° C., which is much higher than that of flexible PHA resins (125 to 150° C.) with longer side chain. Both the lower crystallinity and low melting temperature of flexible PHA resins (Tg is about in the same as that of homopolypropylene, about-5 to 5° C.) with longer side chain result in lower heat resistance and higher heat shrinkage.

### PLA Resins

In an embodiment, PLA resin is considered as a rigid biopolymer with high stiffness due to its high glass temperature at about 55° C. to 60° C. PLA resin is available at large commercial scale with a relatively low cost, therefore, PLA resins are excellent candidates to be used to enhance the stiffness, tensile strength, and Young's modulus of PHA-rich biofilms.

In an embodiment, optimal tensile strength and Young's modulus are required for snack food packaging and label film. The tensile strength and stiffness/flexibility of the composite film can be controlled by balancing the ratio of rigid/flexible components in the core layer.

Examples of PLA resins include NatureWorks Ingeo™ PLA4032D and PLA4043D or PLA2003D or TotalEnergies Corbion Luminy® LX575 and LX175. These resins have a melt flow rate of about 3.9-4.1 g/10 min. at 190° C./2.16 Kg test condition, a melting temperature of about 145-170° C., a glass transition temperature of about 55 to 60° C., a density of about 1.25 g/cm³. Molecular weight Mw is typically about 200,000 g/mole; Mn typically about 100,000 g/mole; polydispersity about 2.0. PLA4032D and LX575 has a melting point of about 165-173° C., which are more preferred crystalline PLA resins for thermal resistance application.

In an embodiment, Ingeo™ PLA4043D and Luminy® LX175 has a melting point of about 145-152° C., lower Tm melting temperature of those PLA resins have the advantages of the capability of melting at lower extrusion temperatures as blended with biopolymers with poor thermal stability such as PHA resins. PLA resins with a Tm of about 150° C. such as LX175 and PLA4043D melt earlier compared to those PLA resins with a Tm of about 165° C. such as LX575 and PLA40432D before PHA resin melts during extrusion.

More preferably, semi-crystalline PLA resins are used as they are in amorphous state and are not crystallized before extrusion. Amorphous PLA resins can soften at lower temperatures (at Tg about 56° C.) and lubricate extrusion and facilitate the melting of PHA resins especially PHB or PHBV resins which have a Tm in the range of from 150 to 178° C., as a result, the extent of PHA thermal degradation can be extremely eliminated. Amorphous semi-crystalline PLA resins can crystallize afterwards during film orientation processes. Therefore, starting with non-pre-crystallized semi-crystalline PLA resins will not change the properties of final PHA-rich film products.

In an embodiment, amorphous PLA resins include NatureWorks Ingeo™ 4060D and TotalEnergies Corbion LuminyR LX975. Those resins have a melt flow index of about 3 to 6 g/10 min. measured at the test condition of 2.16 Kg and 190° C., and a glass transition temperature Tg of about 52 to 60° C. (softening temperature), heat seal initiation temperature of about 93° C., a density of about 1.24 g/cm³.

In an embodiment, semi-crystalline PLA resins, such as Luminy® LX530, Ingeo™ 3801X, and Ingeo™ 3052D having a melt flow rate in the range of 8 to 15 g/10 min. at the test condition of 190° C. and 2.16 Kg and a melting temperature of 145 to 170° C., are especially suitable as modifier in the outer skin layers of the PHA-rich composite film for improving processability such as crystallization, clarity, flowability, and orientation.

In an embodiment, amorphous PLA resins such as and Luminy® LX930 and Ingeo™ 6060D having a melt flow rate in the range of 8 to 15 g/10 min. at the condition of 190° C. and 2.16 Kg are especially suitable as modifier in the outer skin layers of the PHA-rich composite film for improving processability such as flowability and compostability. It is believed that amorphous PLA resins biodegrade faster than that their semi-crystalline counterparts.

In an embodiment, PLA copolymers include but not limited to lactide-rich copolymers such as poly(lactide-co-glycolide) (PLA-co-GA), poly(lactide-co-3hydroxypropionate) (PLA-co-3HP), and poly(lactide-co-ε-caprolactone) (PLA-co-ε-CL) copolymers. The comonomers such as glycolide, 3hydroxypropionate, and ε-caprolactone copolymerized with L and D enantiomers so that those comonomers can be inserted into PLA backbone to improve the flexibility and compostability of PLA copolymer resins. The PLA copolymers can be either semi-crystalline or amorphous, depending on the ratio of the D, L enantiomers as well as non-lactide monomers.

### PBSA Resin

Example of suitable poly(butylene succinate-co-adipate) (PBSA) resins could be but not limited to PTT MCC BioPBS™ FD92PM, which has a glass transition temperature (Tg)−47° C. and a melting temperature (Tm) 87° C., and a melt flow index about 4 g/10 min. at the test condition of 2.16 Kg and 190° C. The heat of fusion for 100% crystalline PBSA crystals is about 110.3 J/g. FD92PM resin is a TUV-certified biopolymer which is home compostable resin defined by TUV Austria Group.

### PCL Resin

Example of suitable Polycaprolactone (PCL) resins could be but not limited to Ingevity CAPA®6500D or CAPA®6800D and CAPATMFB100, which has a glass transition temperature (Tg) about −60° C. and a melting temperature (Tm) about 58° C. The melt flow index is 18 g/10 min. for CAPA6500D and 2.4 g/10 min. for CAPA6800D, tested with 2.16 kg load and 1″ PVC die at 160° C. The CAPATMFB6800 has a melt flow index of about 1.4 g/10 min. at 190° C. and 2.16 Kg condition. The heat of fusion for 100% crystalline PCL crystals is about 135.31 J/g. Those biodegradable polymers are certified for both industrial composting and home composting by TUV Austria Group.

### Other Polymers and Additives

Example of suitable Poly(butylene adipate-co-butylene-terephthalate (PBAT) resins includes not limited BASF Ecoflex® C1200, which has a density of about 1.25 g/cm³, a glass transition temperature of about −30° C., a melt flow index of about 4/10 min. at the condition of 2.16 Kg and 190° C. PBAT is considered as an amorphous biopolymer and is a very rubbery biopolymer with Vicat softness of about 91° C.

Multi-functional epoxidized or maleic anhydride grafted polymeric resins can chemically react with the chain end groups (—COOH) of polyesters.

Examples of suitable multi-functional reactive polymeric resins include Dow Biomax® SG 120 resin and SEBS Kraton™ FG 1924 polymer.

Biomax SG 120 is an epoxidized ethylene-acrylate copolymer or terpolymer (non-biodegradable polyolefin elastomers) having a contemplated structure of ethylene-n-butyl acrylate-glycidyl methacrylate, ethylene-methyl acrylate-glycidyl methacrylate, ethylene-glycidyl methacrylate, or blends thereof. This additive has a density of about 0.94 g/cm³, a melt flow rate of about 12 g/10 min. at 190° C./2.16 kg test condition, a melting point of about 72° C., and a glass transition temperature of about −55° C.

Kraton™ FG 1924 polymer is an amorphous elastomer having a glass transition temperature of −90° C. for its polybutadiene blocks and a Tg of 100° C. for its polystyrene blocks, the weight percentage of polystyrene blocks is only about 17 wt %. Therefore, F G 1924 is a very rubbery material with excellent flexibility for modification at a low loading amount to achieve good noise dampening effect.

In an embodiment, spherical antiblocks are necessary for film making. The spherical antiblocks includes crosslinked silicone polymer such as Tospearl® grades of polymethlysilsesquioxane of nominal 2.0 and 3.0 μm sizes and sodium aluminum calcium silicates of nominal 3 μm or 5 μm in diameter (such as Mistui Silton® JC-30 and JC-50).

PLA10A is an antiblock masterbatch comprising 5 wt % Silton® JC-30 particles and 95 wt % amorphous PLA carrier resin Luminy® LX975. PLA10A was made through toll compounding.

Migratory slip additives may also be added in the biopolymers before film extrusion to control the lubrication of extrusion and the COF properties of a coextruded film. Migratory slip additives include fatty amides such as erucamide, stearamide, oleamide, etc. and silicone oils ranging from low molecular weight oils to ultrahigh molecular weight polysiloxane gums.

### Cavitating Agent

Cavitating agents could be inorganic particles such as CaCO3, silica, talc etc. and organic particles such as well dispersed polypropylene (PP) and cyclic olefin copolymer (COC) with a particle size of about 0.2 to 10 microns. Preferably, the cavitating agent is inexpensive mineral based inorganic cavitating agents for the sake of the view of cost factor and sustainability.

Examples of suitable mineral based cavitating agent include calcium carbonate (CaCO3), silicas, and talc, preferably, more cost competitive CaCO3 as cavitating agent. Calcium carbonate specific gravity is about 2.7 g/cm³ which is higher than that a general range of about 0.90 to 0.96 g/cm³ for most polyolefins and about 1.24 to 1.26 g/cm³ for most biodegradable bioplastics such as PHA and PLA resins. A non-oriented plastic film comprises inorganic filler CaCO3 (no cavitation), the film density could be higher than 1.24 g/cm³ due to the high specific gravity of CaCO3.

Examples of cavitating agent CaCO3 masterbatch in PLA carrier resin include Sukano PLA cc S742, which comprises about 45 wt % CaCO3 in semi-crystalline PLA carrier resin. The PLA carrier resin has a melting temperature of about 150° C.

Another example of cavitating agent CaCO3 masterbatch is PLA13-2, which has 40 wt % CaCO3 in PLA4043D carrier resin. PLA13-2 was made by toll-compounding.

Another example of cavitating agent is JC30 silica particles. PLA10A masterbatch comprising about 5 wt % Silton® JC-30 silica particles and 95 wt % amorphous PLA carrier resin Luminy® LX975. The average particles size of JC-30 silica particle is about 3.0 μm. The PLA10A was made through toll compounding.

### Film Preparation

In an embodiment, the multilayer PHA-rich composite film is a three-layer film comprising a PHA-rich core layer sandwiched by two outer skin layers, the core layer is considered as the base layer to provide the bulk strength and mechanical properties of the oriented composite film.

In an embodiment, the core layer (B) comprises PHA resin at an amount of more than 50 wt % of the total weight of the polymeric resins in the core layer and non-PHA modifier X at an amount of less than 50 wt % of the total weight of the core layer.

In an embodiment, the PHA resins in the core layer include semi-crystalline PHA resins with a glass transition temperature of Tg≤10° C. and a melting temperature in the range of 140 to 180° C. such as PHB, PHBV, PHB-co-3HHx, PHB-co-4HHx, PHB-co-3HO, P3HB-co-4HB, and PHB-co-3HD resins. Preferably, the crystallinity of the PHA resins in the core layer is higher than 35%.

In an embodiment, the modifier X in the core layer comprises biopolymers including PLA, PLA copolymers, PBS, PBSA, and PCL resins with a glass temperature of Tg≤60° C. and a melting temperature Tm in the range of from 56° C.≤Tm≤170° C., preferably, the Tm is in the range of from 56 to 155° C.

In one embodiment, the core layer (B) can include processing aids, antioxidants, plasticizers, nucleating agents, inorganic particles, fillers, lubricants and slip additives.

In one embodiment, cavitating agents could be added to the core layer (B) such that upon biaxial orientation, closed voids are formed within this layer, thus rendering the film a matte or opaque and often, pearlescent white appearance. Such cavitating agents could be inorganic particles such as calcium carbonate (CaCO3), silicas or talc, or other minerals; Titanium oxides may also be incorporated with the cavitating agent to provide a brighter white appearance.

In an embodiment, petroleum-based functional rubbery elastomers such as Kraton™ FG polymer and BIOMAX SG 120 at an amount not more than about 5 wt % of the total weight of the core layer could optionally be added into the core layer as modifier to improve the compatibility between the components in the core layer and the flexibility of the composite film.

In an embodiment, a small amount of chain extenders, plasticizers, nucleating agents, slip additives or mixtures thereof could be added into the core layer as rheology modifier to improve the processability of the composite film.

In an embodiment, the composite film is a monolayer film with a formulation of the core layer described above.

In an embodiment, the composite film comprises a first outer skin layer (A) which is on the top of the core layer.

In an embodiment, the first outer skin layer (A) comprises a polymer blend Y comprising PLA resins or PHA resins or PBSA resins or PCL resins or mixture thereof.

In an embodiment, the PLA resin in the first outer skin layer is at an amount less than 50 wt % of the total weight of the first outer skin layer.

In an embodiment, the PLA resin in the first outer skin layer comprise semi-crystalline PLA resin, amorphous PLA resin and PLA copolymers with a melt flow index of 3 to 15 g/10 min. at the test condition of 190° C. and 2.16 Kg.

In an embodiment, the polymer blend Y comprises PHA resins at an amount of 0 to 90 wt % of the total weight of the outer layer.

In one embodiment, the polymer blend Y comprises PBSA resins at an amount of 0 to 90 wt % of the total weight of the outer layer.

In one embodiment, the polymer blend Y comprises PCL resins at an amount of 0 to 35 wt % of the total weight of the outer skin layer.

In an embodiment, the first outer skin layer comprises a desirable amount of antiblocks and slip additive for slip and blocking control. Antiblock components could be selected from the group consisting of amorphous silicas, aluminosilicates, sodium calcium aluminum silicates, crosslinked silicone polymers, and polymethylmethacrylates to aid in machinability and winding and to lower coefficient of friction (COF) properties. Suitable amounts range from 0.03 to 2 wt % of the heat sealable layer and typical particle sizes of 2.0-6.0 μm in diameter, depending on the final thickness of this layer. A suitable amounts of slip additives can also be included at an amount in the range from 300 ppm to 10,000 ppm of the layer.

In an embodiment, if heat sealing is required for the outer skin layers, a combination of amorphous PLA resin, PBSA and PCL in the desirable loading range has been found not only to sufficiently lower the seal initiation temperature, broaden the heat sealing temperature window, and enhance the plateau seal strength, but also maintain the processability during film-making as well as to help keep the sealant layer home compostable since heat sealable amorphous PLA resin is not home compostable. The quick disintegration of the sealant layer resulted from improved compostability may help the compostability of the total film structure of a composite film product.

Both PBSA and PCL can crystallize much faster than semi-crystalline PHA resins, and they have a sharp crystallization peak, indicating less defect in the crystals of PCL and PBSA, as they cool in sealing process compared to PHA resins. Quick solidifying and crystallization provide a huge advantage to heat sealing performance and lowering heat-sealing cycle time. In addition, both polymers also have the advantage of being fully biodegradable and home compostable and promoting the home compostability of amorphous PLA resins. This is important to maintain the overall biodegradability and/or compostability of the whole multi-layer film structure.

In an embodiment, the composite film comprises a second outer skin layer (C) on the bottom of the core layer (B), opposite the first outer skin layer (A).

In an embodiment, the second outer skin layer comprises a polymer blend Y comprising PLA resins or PHA resins or PBSA resins or PCL resins or mixture thereof

In an embodiment, the second outer skin layer could have the same formulation as the first outer skin layer.

In an embodiment, the second outer skin layer could have a formulation different from that of the first outer skin layer.

In an embodiment, the outer skin layers of the composite film could be formulated for the purpose of heat sealable layer, print ink receiving layer, metal receiving layer or coating receiving layer.

If desired, all three layers of the film could comprise the same materials, thus rendering the overall multi-layer film a monolayer composite film.

If desired, in an embodiment, the outer skin layers could be discharge-treated for lamination, metallizing, printing, or coating. Discharge-treatment in the above embodiments can be accomplished by several means, including but not limited to corona, flame, plasma, or corona in a controlled atmosphere of selected gases.

In an embodiment, this invention provides a method to produce biaxially oriented cavitated PHA-rich composite film with reduced film density and low light transmission while the heat-sealing properties, mechanical properties and compostability can be maintained at a level required for the application of packaging and label films.

### EXAMPLES

This invention will be better understood with reference to the following examples, which are intended to illustrate specific embodiments within the overall scope of the invention.

Thermal properties as well as melt flow rates of the biopolymers used in Examples are shown in Table 1. The glass transition temperature Tg and melting temperature Tm of the biopolymers are obtained from DSC experiments on the materials. The heat of fusion of the biopolymers measured through DSC experiments was used to determine the crystallinity (Xc) of the biopolymers according to the heat of fusion of 100% perfect crystals of those biopolymers obtained from literature.

The compositions of each layer of the coextruded composite films made in Examples are shown in Table 2a, 2b and 2c.

The multi-layer composite film was made using a process of coextrusion and sequential orientation. The coextrusion was conducted at temperatures of about 160° C. to 210° C. by pushing materials through a flat die, cast the polymer curtain at a desirable casting speed on a chill drum with temperatures controlled between 15° C. and 35° C. using an electrostatic pinner, and then oriented in the machine direction 2 to 3.5 times through a series of heated and differentially sped rolls controlled at about 50° C. to 70° C., followed by transverse direction stretching about 3 to 5.5 times in a tenter oven with temperatures controlled at about 75° C. to 90° C. and then annealed at about 90° C. to 140° C. to reduce internal stresses to minimize shrinkage and give a relatively thermally stable biaxially oriented sheet. It is also beneficial to relax about 5 to 15% of the maximum width of the tenter orientation after the stretching section.

A three-layer coextruded biaxially oriented PLA film (BOPLA) was made as control using sequential orientation on a 12-inch-wide flat die line as described previously, including non-heat sealable layer (A), a core layer (B), a heat sealable layer (C). The core layer was sandwiched between two outer skin layers. The PLA10A is a 5 wt % JC-30 (silica particles) masterbatch in 95 wt % LX975 carrier resin. PLA10A was added into outer skin layers for the purpose of COF control and anti-blocking. The content of JC-30 particles in the non-heat sealable outer layer (A) is about 500 ppm and the content of JC-30 antiblock in the heat seal layer (C) is about 3000 ppm.

The dry blended resins of the core layer and the outer skin layers were melt coextruded individually in extruders A (first outer layer, cast side layer, top layer), B (core layer) and C (second outer layer, air side, bottom layer) at temperatures of about 204° C. The molten resins flowed through a set of screen pats and individual melt pipes and then met inside the die body of a twelve-inch flat die set at temperature of about 204° C., resulting in a curtain of molten resin. In general, the residence time of polymer melt between the entrance of each extruder and the exit of the die body was estimated at about 10 to 15 min., varying with the rpm of extruders and the length of pipes. The resin curtain was then cast on a chilled drum (set at temperature about 30° C.) using an electrostatic pinner. The formed cast sheet was stretched at about 2.8 times in the machine direction (MD) through rolls set at temperatures between 40° C. to 65° C. and then stretched at about 5.3 times in transverse direction (TD) in a tenter oven set temperatures 65 to 82° C. The resultant biaxially oriented film was subsequently heat set at about 138° C. and then relaxed at about 10% in TD, followed by discharge-treated on the surface of the non-heat sealable skin layer (A) by corona treatment. The film was then wound up in roll form.

The total thickness of this PLA control film was about 20 μm. The thickness of the respective heat sealable resin layer (C) after biaxial orientation was about 2.0 μm. The thickness of the core layer (B) after biaxial orientation was about 17.0 μm. The thickness of the non-sealable skin layer (A) was about 1.0 μm.

### Example 2

Example 1 was repeated while the process conditions and formulations were changed. The core layer was changed to a blend of about 60 wt % PHBV Y1000P resin and 40 wt % oLX175 resins. An optimum reverse extrusion temperature profile from high at about 193° C. to low at about 160° C. was used in extrusion. The melt pipe temperature of the extruder B was controlled at less than 165° C., at which thermal degradation observed for PHA resins could start. The formulation for the first outer skin layer A was changed to a blend of about 24 wt % LX975, 70 wt % FD92PM, and 6 wt % PLA10A; and the formulation for the second outer skin layer C was changed to a blend of about 34 wt % LX975, 50 wt % FD92PM, 10 wt % CAPA6500D, and 6 wt % PLA10A. The core layer and both outer skin layers comprised about 60 wt % TUV-certified home compostable biopolymers. There is no PHA resin in the outer skin layers.

The extrusion temperatures of extruders for layers A and C were at about 193° C. The temperature of the die body was set at about 175° C. The molten polymer melt was cast on a chilled roll set at about 30° C. to form a cast sheet with a width about 9.5 inches. The sheet was oriented in machine direction for 2.8 times and then in transverse direction for 4.5 times. The composite film was heat set at 138° C. and relaxed for 10% in TD and then corona-treated under conditions described previously. The thickness of the coextruded oriented laminate film is about 15 μm.

### Example 3

Example 2 was repeated, and the content of Y1000P resin in the core layer was increased to about 70 wt % and LX175 PLA resin was reduced to about 30 wt %. The formulation for the first outer skin layer A was changed to a blend of about 24 wt % LX975, 60 wt % FD92PM, 10 wt % CAPA6500D, and 6 wt % PLA10A. Both outer skin layers have the same recipe. The heat set temperature was reduced to about 104° C. The film thickness is about 24 μm.

The PHA-rich composite film has about 70 wt % TUV-certified home compostable biopolymers in all three layers. There is no PHA resin in the outer skin layers. The PHA-rich composite film in Examples 2 to 3 is two-side heat sealable.

### Example 4

Example 2 was repeated, the recipe of the core layer was changed to a blend of 60 wt % BP330-05 and 40 wt % PLA4043D. The recipes of the outer skin layers A and C were changed to a blend of 70 wt % BP330-05, 29 wt % PLA4043D and 1 wt % PLA10A. The extrusion temperatures for the outer skin layers were changed to a similar profile of the core layer to avoid potential thermal degradation for BP330-05 resin during extrusion. The heat set temperature was changed to about 127° C. The film thickness is about 29 μm.

### Example 5

Example 4 was repeated, the recipe of the second outer skin layer C was changed to a melt blend compound with about 34 wt % LX930, 50 wt % FD923PM, 10 wt % CAPA6500D and 6 wt % PLA10A. There was no change for the recipes of the core layer and the first outer skin layer A. The film has a thickness of about 20 μm. Amorphous PLA resin LX930 has a high MFR of 11.5 g/10 min. at the test condition of 190° C./2.16 Kg.

### Example 6

Example 5 was repeated, the recipe was changed to a blend of about 40 wt % PLA4043D and about 60 wt % BP330-05 for all three layers, the coextruded film becomes a monolayer film. The film has a thickness of about 24 μm.

### Comparative Example 1 (CEx. 1)

Example 5 was repeated, the recipe of the core layer was changed to a blend of about 55 wt % BP330-05, 25 wt % PLA4043D and 20 wt % PLA cc S742. There is no change for the recipes of both outer skin layers A and C. PLA cc S742 is a 45 wt % CaCO3 masterbatch in semi-crystalline PLA carrier resin which has a Tm of about 150° C. The content of neat CaCO3 particles in the core layer is about 9 wt %. The PHA-rich composite film was cavitated in the core layer and has a thickness of about 28 μm. The cavitated film is printable and heat sealable.

### Comparative Example 2 (CEx. 2)

Example 6 was repeated, the recipe of the two outer layers was changed to a blend of 60 wt % BP330-05 and 40 wt % LX530 and the recipe of the core layer was changed to a blend of 55 wt % BP330-05, 22 wt % PLA4043D, and 23 wt % PLA13-2. PLA13-2 has 40 wt % CaCO3 particles in PLA4043D carrier resin. The content of neat CaCO3 particles in the core layer is about 9.2 wt %. The coextruded oriented film is cavitated with closed voids in the core layer. The film has a thickness of about 31 μm.

### Comparative Example 3 (CEx. 3)

Example 6 was repeated, except that the core layer was changed to a blend of 55 wt % BP330-05, 33 wt % PLA4043D and 12 wt % PLA10A. The content of neat JC30 particles in the core layer is about 0.6 wt %. The coextruded oriented film has a light cavitation in the core layer. The film has a thickness of about 24 μm.

TABLE 1
MFR* and thermal properties of biopolymers in Examples

| | | | | | | | TUV- |
|---|---|---|---|---|---|---|---|
| MFR and thermal properties of semi-crystalline biopolymers | | | | | | | certified |
| | | MFR | | | | | for Home |
| | Resin | (g/10 | Tg | Tm | DH | Xc | Com- |
| Grade | type | min.) | (° C.) | (°C.) | (J/g) | (%) | postable |
| LX575 | PLA | 3.9 | 56 | 166 | 35 | 37 | No |
| LX175 | PLA | 4.3 | 56 | 152 | 36 | 38 | No |
| LX530 | PLA | 9.3 | 56 | 163 | 37 | 40 | No |
| LX930 | PLA | 11.5 | 56 | NA | | | No |
| LX975 | PLA | 5.3 | 56 | NA | | | No |
| PLA4043D | PLA | 5.9 | 56 | 150 | 34 | 36 | No |
| Y1000P | PHA | 12.1 | 2 | 173 | 106 | 73 | Yes |
| BP330-05 | PHA | 6.3 | −4 | 149 | 56 | 38 | Yes |
| FD92PM | PBSA | 4.9 | −47 | 87 | 42 | 38 | Yes |
| CAPA6500D | PCL | 29 | −60 | 59.4 | 70.1 | 52 | Yes |

*MFR of all PLA and PCL resin was tested at the condition of 190° C. and 2.16 Kg; MFR of BP330-05 resin was tested at the condition of 165° C. and 2.16 Kg; and MFR of Y1000P resin was tested at the condition of 185° C. and 2.16 Kg.

TABLE 2a
The composition of the core layer of the PHA-rich composite
films in Examples (“Ex.”) or comparative Examples (“CEx.”)
Composition of core layer (B)-wt %

| | Ex. | Ex. | Ex. | Ex. | Ex. | Ex. | CEx. | CEx. | CEx. |
|---|---|---|---|---|---|---|---|---|---|
| Example | 1 | 2 | 3 | 4 | 5 | 6 | 1 | 2 | 3 |
| LX575 | 81 | | | | | | | | |
| LX975 | 15 | | | | | | | | |
| Biomax | | | | | | | | | |
| SG120 | 4 | | | | | | | | |
| LX175 | | 40 | 30 | | | | | | |
| PLA4043D | | | | 40 | 40 | 40 | 25 | 22 | 33 |
| Y1000P | | 60 | 70 | | | | | | |
| BP330-05 | | | | 60 | 60 | 60 | 55 | 55 | 55 |
| PLA cc | | | | | | | 20 | | |
| S742 | | | | | | | | | |
| PLA13-2 | | | | | | | | 23 | |
| PLA10A | | | | | | | | | 12 |

TABLE 2b
The composition of the first outer skin layer of the PHA-rich composite
films in Examples (“Ex.”) or comparative Examples (“CEx.”)
Composition of first outer layer (A, cast side)-wt %

| | Ex. | Ex. | Ex. | Ex. | Ex. | Ex. | CEx. | CEx. | CEx. |
|---|---|---|---|---|---|---|---|---|---|
| Resin | 1 | 2 | 3 | 4 | 5 | 6 | 1 | 2 | 3 |
| PLA10A | 1 | 6 | 6 | 1 | 1 | | 1 | | |
| LX175 | 84 | | | | | | | | |
| LX975 | 15 | 24 | 24 | | | | | | |
| FD92PM | | 70 | 60 | | | | | | |
| CAPA ™ | | | 10 | | | | | | |
| 6500D | | | | | | | | | |
| BP330-05 | | | | 70 | 70 | 60 | 70 | 60 | 60 |
| PLA4043D | | | | 29 | 29 | 40 | 29 | 40 | 40 |

TABLE 2c
The composition of the second outer skin layer of the PHA-rich composite
film in Examples (“Ex.”) or Comparative Examples (“CEx.”)
Composition of second outer layer (C, air side)- wt %

| | Ex. | Ex. | Ex. | Ex. | Ex. | Ex. | CEx. | CEx. | CEx. |
|---|---|---|---|---|---|---|---|---|---|
| Resin | 1 | 2 | 3 | 4 | 5 | 6 | 1 | 2 | 3 |
| PLA10A | 6 | 6 | 6 | 1 | 6 | | 6 | | |
| LX975 | 34 | 24 | 24 | | | | | | |
| FD92PM | 50 | 60 | 60 | | 50 | | 50 | | |
| CAPA ™ | 10 | 10 | 10 | | 10 | | 10 | | |
| 6500D | | | | | | | | | |
| BP330-05 | | | | 70 | | 60 | | 60 | 60 |
| PLA4043D | | | | 29 | | 40 | | 40 | 40 |
| LX930 | | | | | 34 | | 34 | | |

### Film Properties

The biaxially oriented coextruded PHA-rich composite films were tested for the properties of mechanical strength, tear resistance, optical properties, heat shrinkage (heat resistance), elongation force (resistance to a pulling fore), film density and yield, which are basic film properties required for packaging and label films.

The mechanical strength and tear resistance of the PHA-rich composite films made in Examples were shown in Table 3. A typical BOPP film was included for comparison, which was obtained from a commercial clear BOPP film (Torayfan® YOR4/70G with a thickness of about 17.5 μm which was made in standard BOPP production line). The properties of a BOPP film would be a good benchmark for biofilm development.

TABLE 3
Mechanical properties of the biaxially oriented coextruded PHA-
rich composite films made in Examples (“Ex.”) or comparative
Examples (“CEx.”), that of a BOPP film used as comparison.

| | Tensile | | Elongation | | Young's | | Tear strength | | |
|---|---|---|---|---|---|---|---|---|---|
| | strength | | at break | | modulus | | (gram force/mil) | | |
| | (MPa) | | (%) | | (MPa) | | | | MD/ |
| Example | MD | TD | MD | TD | MD | TD | MD | TD | TD |
| BOPP | 115 | 234 | 176 | 30 | 1658 | 2536 | 7.5 | 6.4 | 1.2 |
| Ex. 1 | 97 | 160 | 130 | 89 | 2900 | 4236 | 14.1 | 9.3 | 1.5 |
| Ex. 2 | 70 | 129 | 95 | 58 | 3134 | 4052 | 15.8 | 11.8 | 1.3 |
| Ex. 3 | 94 | 152 | 117 | 67 | 2851 | 3920 | 9.5 | 4.0 | 2.4 |
| Ex4 | 73 | 125 | 150 | 94 | 2508 | 3295 | 12.8 | 9.4 | 1.4 |
| Ex. 5 | 89 | 132 | 187 | 97 | 2770 | 2188 | 10.4 | 7.7 | 1.4 |
| Ex. 6 | 98 | 162 | 167 | 81 | 3089 | 3791 | 11.5 | 6.8 | 1.7 |
| CEx. 1 | 65 | 109 | 167 | 70 | 1888 | 1850 | 9.1 | 5.6 | 1.6 |
| CEx. 2 | 55 | 101 | 137 | 78 | 2459 | 2861 | 13.4 | 5.5 | 2.4 |
| CEx. 3 | 72 | 125 | 173 | 79 | 2857 | 3168 | 14.7 | 7.2 | 2.0 |

TABLE 4
Optical properties of the biaxially oriented coextruded
PHA-rich composite films made in Examples (“Ex.”) or
comparative Examples (“CEx.”)

| | | | |
|---|---|---|---|
| H. S. | | | |
| temp. | Thick. | Haze | Gloss |

| Example | ° C. | μm | % | A/60° | C/20° |
|---|---|---|---|---|---|
| Ex. 1 | 138 | 20 | 5 | 92 | 46 |
| Ex. 2 | 138 | 15 | 35 | 67 | 6 |
| Ex. 3 | 104 | 24 | 23 | 94 | 24 |
| Ex. 4 | 127 | 29 | 23 | 42 | 9 |
| Ex. 5 | 127 | 20 | 12 | 68 | 16 |
| Ex. 6 | 127 | 24 | 8 | 75 | 35 |
| CEx. 1 | 121 | 28 | 102 | 68 | 10 |
| CEx. 2 | 127 | 31 | 98 | 69 | 20 |
| CEx. 3 | 127 | 24 | 47 | 69 | 30 |

TABLE 5
Heat shrinkage of the biaxially oriented coextruded PHA-
rich composite films made in Examples (“Ex.”) or
comparative Examples (“CEx.”)

Heat shrinkage at 120° C. and
15 min. duration time

| Example | MD | TD |
|---|---|---|
| Ex. 1 | 7% | 3% |
| Ex. 2 | 4% | 7% |
| Ex. 3 | 12% | 32% |
| Ex4 | 3% | 6% |
| Ex. 5 | 2% | 5% |
| Ex. 6 | 3% | 10% |
| CEx. 1 | 3% | 17% |
| CEx. 2 | 3% | 6% |
| CEx. 3 | 3% | 10% |

TABLE 6
Elongation force of the biaxially oriented coextruded PHA-rich
composite films made in Examples (“Ex.”) or comparative
Examples (“CEx.”), normalized to 1 mil thickness (25 μm).

| | Elongation force (gram/in-mil) | | |
|---|---|---|---|
| Example | 3% | 6% | 9% |
| Ex. 1 | 13248 | 14379 | 14109 |
| Ex. 2 | NA | NA | NA |
| Ex. 3 | 16525 | 16217 | 16940 |
| Ex4 | 13361 | 13621 | 13798 |
| Ex. 5 | 13372 | 14717 | 15078 |
| Ex. 6 | 11119 | 11353 | 11345 |
| CEx. 1 | 11939 | 13140 | 13462 |
| CEx. 2 | 9467 | 10074 | 10812 |
| CEx. 3 | 12154 | 12307 | 12717 |

As expected, BOPP film showed better mechanical properties outperforming most of the biofilm samples. The PLA control sample (Ex. 1) showed the highest tensile strength as well as Young's modulus in both MD and TD although it has a soft heat sealable outer layer (C), which can reduce the film modulus and noise and improve heat seal performance.

Non-cavitated PHA-rich composite films made in Examples 2 to 6 showed a tensile strength at about 70 to 94 MPa in MD and about 129 to 162 MPa in TD, respectively, which are slightly lower than that of BOPLA film showed in Example 1. The Young's modulus of the PHA-rich composite film was about 2500 to 3100 MPa in MD and about 2100 to 4000 MPa in TD which on average are also slightly lower than that of BOPLA film. All PHA-rich composite film samples showed good elongation at break suitable for downstream processability. However, the elongation in TD is much higher than that of BOPP film.

The MD tear strength of the PHA-rich composite films made in Examples is significantly higher than the TD shear strength so that the ratio of tear strength MD/TD is >1. The tear strength in Table 3 was normalized to one-mil-thick film for comparison. A higher tear strength in machine direction is one of the important properties for biaxially oriented composite films.

### Properties of Cavitated PHA-Rich Film

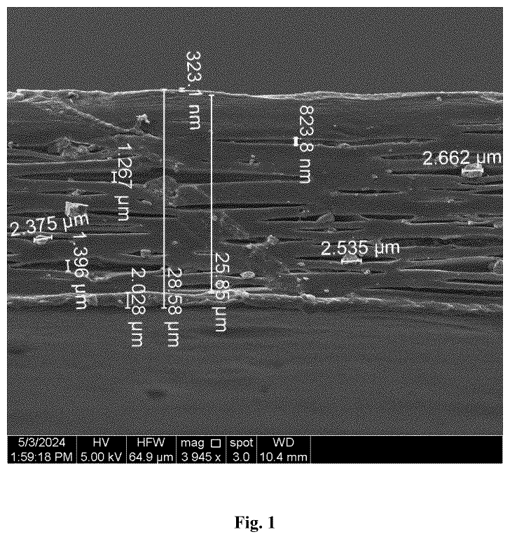

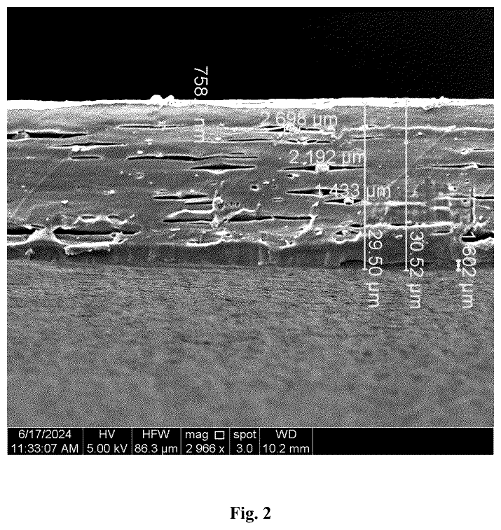

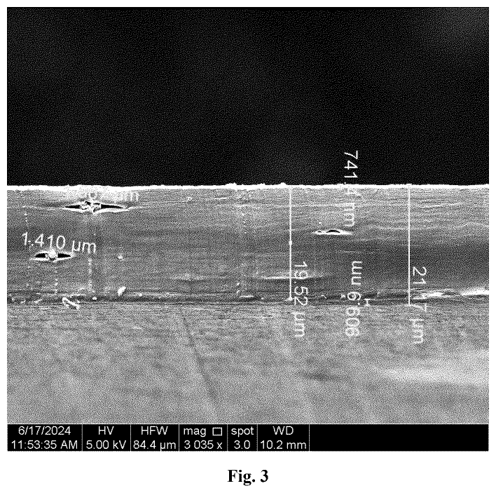

The SEM cross-sectional images of the cavitation of the PHA-rich composite film are shown in FIG. 1 and FIG. 2 as well as FIG. 3 obtained from the film samples made in comparative Examples 1 to 3 (CEx. 1, CEx. 2 and CEx. 3). Particles and elongated voids were observed on the SEM images.

FIG. 1 showed that the thickness of the bottom layer was measured at about 2 μm, the thickness of the composite film was measured at about 28 μm, the boundary between the core layer and the top layer is not clear due to the similarity in recipe, while the thickness of the top layer was set for about 2 μm in film making by controlling the rpm of the extruder for the top layer (A side, the first outer skin layer). It is noted the cavitation in the core layer on the side of the first outer layer is less than on the side of sealant layer.

FIG. 2 showed that the PHA-rich composite film is less cavitated in terms of the number of voids and the size of voids compared to that in FIG. 1

FIG. 3 showed that the PHA-rich composite film is lonely lightly cavitated, there are only a few small voids on the cross-section of SEM image.

Although non-cavitated PHA-rich composite films showed hazes higher than that of conventional transparent packaging film such as BOPP and BOPLA films, the hazes are not high enough to block light (Table 4). After cavitation, the cavitated PHA-rich composite film showed a haze able to block light transmission.

As shown in Table 4 and 7, the cavitated PHA-rich composite films made in CEx. 1 2, and 3 showed a haze of about 102%, 98% and 47%, and a light transmission of about 59%, 72 and 90%, respectively. The film made in CEx. 3 is a lightly cavitated film due to its low loading in cavitating agent, which has a high light transmission compared to that of highly cavitated films made in CEx. 1 and 2. The higher haze a film has, the lower light transmission rate.

As shown in Table 7, the film density of the cavitated films made in CEx. 1, 2 and 3 is about 1.025 g/cm³, 1.067 g/cm³ and 1.157 g/cm³, respectively, which are lower than that of non-cavitated film made in Ex. 5 with a density of about 1.235 g/cm³. The variation in film density is an indicator of the degree of cavitation. The lower film density a film has, the higher degree of cavitation.

With cavitation, film density and light transmission rate were reduced significantly, haze was increased to a level higher than that of a matte film about 50 to 70%.

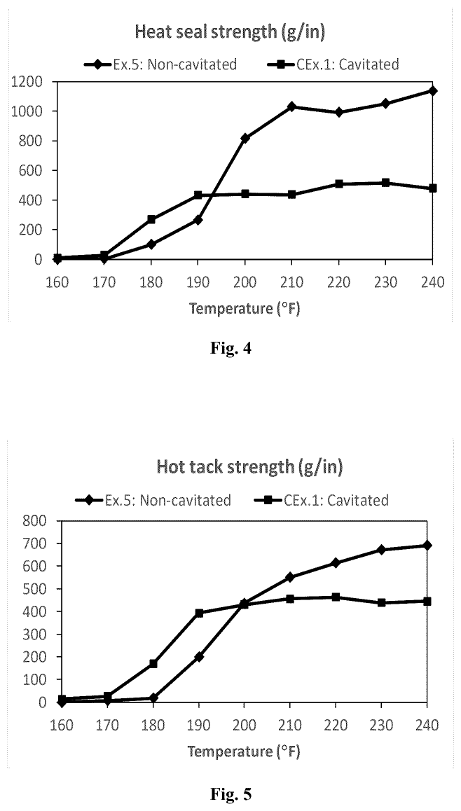

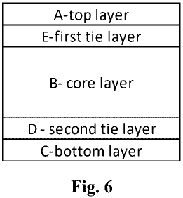

It is well known in industries that a drawback of cavitation is its impairment to mechanical properties and heat seal strength by comparing the properties of a non-cavitated film. The cavitated composite film made in CEx. 1 showed slightly lower mechanical strength and heat seal strength than its counterpart non-cavitated film made in Ex. 5 as shown in Table 4 and FIGS. 4 and 5. The cavitated film made in CEx. 2 also showed lower mechanical strength than that of non-cavitated film made in Ex. 6. The film made in CEx. 3 with a much lower degree of cavitation, it showed an insignificant reduction in mechanical properties compared to the reduction observed for the cavitated films made CEx. 1 and 2 which have much higher degree of cavitation. The cavitated films made CEx. 1 and 2 have similar core recipes in terms of the content of cavitating agent about 9 wt % CaCO3 while two cavitated film samples showed a different film density (Table 7), which could be resulted from the different efficient of cavitating agent regarding the values of particle distribution and particle size as well as surface treatment of particles.

The cavitated film in CEx. 1 showed higher heat shrinkage compared to that of the non-cavitated film made Ex. 5, which could have been induced by lower annealing temperature 121° C. as well as the shrinkage of voids in the core layer under test temperature.

The elongation force (normalized to on mil thickness) was tested at 3%, 6% and 9% elongation rates in machine direction and the results were showed Table 6 (The elongation force of example 2 was not tested due to short of film sample). It is noted that the elongation force of the cavitated film sample made in CEx. 1 and CEx. 2 is lower than their non-cavitated film made in Ex. 5 and Ex. 6. High elongation force is required to the application with resistance to pull in machine direction. The value of elongation force of the invented cavitated PHA-rich composite film is still in a good range to provide resistance to a pulling force such as a tension applied to downstream processing and winding of a packaging and label film.

The film sample made in CEx. 3 with a very low cavitation in the core layer showed much less reduction in mechanical strength and elongation force compared to that of heavily cavitated film samples made in CEx. 1 and 2. Physical properties of a cavitated film can be controlled by the degree of cavitation.

The heat seal and hot tack strengths of the cavitated and non-cavitated PHA-rich composite films were compared and shown in FIGS. 4 and 5. The cavitated film showed a plateau seal strength at about 400 g/in which is lower than that of non-cavitated film at about 1000 g/in but its SIT was shifted to a lower temperature from about 186° F. to about 177° F. A similar trend was observed for the hot tack strength and SIT of the cavitated PHA-rich composite film. The hot tack strength was reduced from 600 g/in to about 400 g/in. However, the plateau seal strength at 400 g/in is sufficient for a heat sealable film, the value is comparable to that of conventional BOPLA film and BOPP film (such as commercial product YMR4/70G film).

Overall, the cavitated PHA-rich composite film showed mechanical properties, heat sealing strength and heat shrinkage slightly lower than its counterpart of non cavitated film. It provides comprehensive properties in the range of fit-for-use for packaging and label film applications while gives the benefits of cost reduction and opacity while maintaining the properties of biodegradation and compostability.

TABLE 7
Comparison on the haze, film density, yield, and light transmission
of non-cavitated and cavitated PHA-rich composite films

| | Thick. | CaCO3 | JC30 | Haze | Light Trans. | Density | Yield | |
|---|---|---|---|---|---|---|---|---|
| Example | (μm) | (wt %) | (%) | (%) | (%) | (g/cm³) | (in²/lb) | Cavitation |
| Ex. 5 | 21 | 0 | | 12 | 93 | 1.235 | 21713 | Control, no |
| Ex. 6 | 24 | 0 | | 8 | 94 | NA | NA | Control, no |
| CEx. 1 | 28 | 9 | | 102 | 59 | 1.025 | 23732 | cavitated |
| CEx. 2 | 31 | 9.2 | | 98 | 72 | 1.067 | 20460 | cavitated |
| CEx. 3 | 24 | 0 | 0.6 | 47 | 90 | 1.157 | 26144 | light |
| | | | | | | | | cavitation |

### Test Methods

The various properties in the above examples were measured by the following methods:

Differential scanning calorimetry (DSC) was used to determine the melting temperature Tm as well as glass transition temperature of the biopolymers in accordance with ASTM D3418. The heat of fusion of the biopolymers measured through DSC experiments was used to determine the crystallinity (Xc) of the biopolymers according to the heat of fusion of the perfect crystals of those biopolymers obtained from literature.

Light transmission of the film was measured by measuring light transmission of a single sheet of film via a light transmission meter (BYK Gardner Haze-Gard Plus) substantially in accordance with ASTM D1003. As per ASTM D1003, Light that is scattered upon passing through a film or sheet of a material can produce a hazy or smoky field when objects are viewed through the material. Regular luminous transmittance is obtained by placing a clear specimen at some distance from the entrance port of the integrating sphere. However, when the specimen is hazy, the total hemispherical luminous transmittance must be measured by placing the specimen at the entrance port of the sphere. The measured total hemispherical luminous transmittance will be greater than the regular luminous transmittance, depending on the optical properties of the sample. With this test method, the specimen is necessarily placed at the entrance port of the sphere in order to measure haze and total hemispherical luminous transmittance.

Haze is measured by calculating the ratio of the diffuse/scattered light relative to the total light transmitted by a single sheet of a film using a hazemeter model like a BYK Gardner “Haze-Gard Plus®” substantially in accordance with ASTM D1003. Preferred values for haze was about 8% or higher for a matte appearance.

Gloss of the film was measured by measuring the desired side of a single sheet of a film by a surface reflectivity gloss meter (BYK Gardner Micro-Gloss) substantially in accordance with ASTM D2457. The A-side was measured at a 60° angle; the C side was measured at a 20° angle.

Mechanical properties of the coextruded composite films were tested under ambient temperature conditions using the method of ASTM D882.

Tear resistance of the coextruded composite film was measured substantially in accordance with ASTM D1922-09. Three samples each are cut from the plastic film samples in the machine direction (MD) and in the transverse direction (TD) for testing and data collection. The tear strength was normalized to one mil thick film.

Heat shrinkage of the coextruded composite films was measured substantially in accordance with ASTM D1204 except that the measurement condition was at a temperature of 120° C. for a process duration time of 15 minutes. The heating medium in this test method is air.

Film density was calculated by cutting a stack of 10 sheets of film using a die-cutter and die of 2.5 inch (6.35 cm) diameter for a surface area of 4.91 in² (31.67 cm²). This die-cut stack of film is weighed on an analytical balance, thickness measured using a micrometer, and the density of the film is then calculated.

SEM cross-section image of the cavitated PHA-rich film was obtained using scanning electron microscopy, a cavitated film sample was mounted in epoxy, freeze-fractured by immersing in liquid nitrogen, plasma-etched and carbon-coated prior to analysis. Microscopy was done at 3945× magnification.

This invention discloses several numerical ranges in the text, tables and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown in the description but is to be accorded the widest scope consistent with the principles and features disclosed herein.

### General Definitions

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items, and may be used interchangeably with “one or more.” Furthermore, as used herein, the term “set” is intended to include items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As defined herein, “approximately” or “about” or similar terms can, in some embodiments, mean within plus or minus ten percent of the stated value. In other embodiments, “approximately” or “about” can mean within plus or minus five percent of the stated value. In further embodiments, “approximately” or “about” can mean within plus or minus three percent of the stated value. In yet other embodiments, “approximately” or “about” can mean within plus or minus one percent of the stated value.

The recitations of numerical ranges by endpoints include all numbers subsumed within that range (e.g., 1 to 5 includes 1, 1.5, 2, 2.75, 3, 3.80, 4, 5, etc.). Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present specification. At the very least, and not as an attempt to limit the doctrine of equivalents to the scope of the claims, each numerical parameter should at least be construed in light of the number of reported significant digits and by applying ordinary rounding techniques.

Some ranges are disclosed herein. Additional ranges may be defined between any values disclosed herein as being exemplary of a particular parameter. All such ranges are contemplated and within the scope of the present disclosure. Further, recitation of ranges of values herein is intended to serve as a shorthand method of referring individually to each separate value falling within the range. Unless otherwise indicated herein, each individual value is incorporated into the specification as if it were individually recited herein.

Notwithstanding that the numerical ranges and parameters setting forth the broad scope of the specification are approximations, the numerical values set forth in the specific examples are reported as precisely as possible. All numerical values, however, inherently contain a range necessarily resulting from the standard deviation found in their respective testing measurements.

All numbers expressing quantities of ingredients, constituents, conditions, and so forth used in the specification and claims are to be understood as being modified in all instances by the term “about”. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Unless otherwise stated, all percentages, ratios, parts, and amounts used and described herein are percentage by weight (wt %). Unless stated otherwise, molecular weight values are for weight average molecular weights.

The present invention is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For the purpose of clarity, details relating to technical material that is known in the technical fields related to the invention have not been described in detail so as not to unnecessarily obscure the present invention.

### REFERENCES

All references, including granted patents and patent application publications, referred herein are incorporated herein by reference in their entirety.

1. A biaxially oriented film comprising a core layer and an outer layer,
wherein the core layer comprises two or more polymers that are not miscible but compatible, the core layer is a PHA-rich core layer comprising polyhydroxyalkonate (PHA) resin more than 50 wt % of a total weight of the polymeric resin in the core layer,
wherein the outer layer comprises a polymer blend Y comprising polylactic acid resin less than 50 wt % of a total weight of the outer layer,
wherein the film is a cavitated film comprising a cavitation agent in an amount about in an amount about 2 to 30 wt % of the total weight of the core layer,
wherein a density of the core layer and the outer layer without the cavitation agent is more than 1.2 gm/cm³, and a density of the biaxially oriented film having cavitation agent in the core layer is less than 1.1 gm/cm³.

2. The biaxially oriented film of claim 1, wherein the cavitation agent comprises calcium carbonate and/or titanium oxide.

3. The biaxially oriented film of claim 1, wherein the core layer further comprises a non-PHA modifier X.

4. The biaxially oriented film of claim 3, wherein the non-PHA modifier X comprises one or more resins having glass transition temperatures Tg≤60° C.

5. The biaxially oriented film of claim 1, wherein the outer layer further comprises a polymer blend Y comprising TUV certified home compostable polymeric resins at an amount more than 50 wt %.

6. The biaxially oriented film of claim 5, wherein the polymer blend Y in the outer layer comprises PLA resins, PHA resins or PBSA resins or PCL resins or mixtures thereof.

7. The biaxially oriented film of claim 1, wherein the biaxially oriented film is biodegradable as per ASTM D 5338-15 and home compostable as per AS 5810-2010 standard.

8. The biaxially oriented film of claim 1, wherein the PHA resin in the core layer has a melting temperature of about 145° C. to 180° C. and a crystallinity higher than 35%.

9. The biaxially oriented film of claim 1, wherein the cavitating agent in the core layer comprises organic and inorganic particles with a particle size of about 0.1 microns to 10 microns.

10. (canceled)

11. The biaxially oriented film of claim 1, wherein the film further comprises an additional outer layer opposite to a first outer layer such that the core layer is sandwiched between two outer layers.

12. The biaxially oriented film of claim 1, wherein the outer layer is a heat sealant layer.

13-15. (canceled)

16. The biaxially oriented film of claim 1, wherein the haze of biaxially oriented film is more than 45% as measured according to ASTM D1003.

17-22. (canceled)

23. A biaxially oriented film comprising a core layer and an outer layer,
wherein the core layer comprises two or more polymers that are not miscible but compatible, the core layer is a PHA-rich core layer comprising polyhydroxyalkonate (PHA) resin more than 50 wt % of a total weight of the polymeric resins in the core layer,
wherein the outer layer comprises a polymer blend Y comprising polylactic acid resin less than 50 wt % of a total weight of the outer layer,
wherein the film is a cavitated film comprising a cavitation agent in an amount about in an amount about 2 to 30 wt % of the total weight of the core layer,
wherein a density reduction of the cavitated film with respect to the density of a non-cavitated biaxially oriented film having same polymer composition is about 5% or more.

24. The biaxially oriented film of claim 23, wherein the density of the cavitated film is less than 10% to 25% compared to the density of non-cavitated biaxially oriented film.

25-27. (canceled)

28. The biaxially oriented film of claim 23, wherein the outer layer comprises TÜV-certified home compostable resins at least about 50 wt % of the total weight of the outer skin layer.

29. (canceled)

30. The biaxially oriented film of claim 23, wherein the weight of one or more outer layers in an amount of about 1 to 25 wt % of the total weight of the core layer.

31-35. (canceled)

36. A biaxially oriented film comprising a core layer and an outer layer,
wherein the core layer comprises two or more polymers that are not miscible but compatible, the core layer is a PHA-rich core layer comprising polyhydroxyalkonate (PHA) resin more than about 50 wt % of a total weight of the polymeric resins in the core layer,
wherein the outer layer comprises a polymer blend Y comprising polylactic acid resin less than 50 wt % of a total weight of the outer layer,
wherein the film is a cavitated film comprising a cavitation agent in an amount about in an amount about 2 to 30 wt % of the total weight of the core layer;
wherein the biaxially oriented film is biodegradable as per ASTM D 5338-15 and home compostable as per AS 5810-2010 standard.

37. The biaxially oriented film of claim 36, wherein the said film is a non-breathable film.

38. (canceled)

39. The biaxially oriented film of claim 36, wherein a light transmission of the biaxially oriented film is less than 72% of transmission of a visible light from an emitter to a sensor of a light transmission measurement device.
